(19) United States
(12) Patent Application Publication
(10) Pub. No.: US 2012/0230583 A1
(43) Pub. Date: Sep. 13, 2012

(54) OBJECT REGION EXTRACTION DEVICE, OBJECT REGION EXTRACTION METHOD, AND COMPUTER-READABLE MEDIUM

(75) Inventor: Tetsuo Inoshita, Tokyo (JP)

(73) Assignee: NEC CORPORATION, Tokyo (JP)

(21) Appl. No.: 13/510,507

(22) PCT Filed: Nov. 10, 2010
(86) PCT No.: PCT/JP2010/006612

§ 371 Date: May 17, 2012

(30) Foreign Application Priority Data
Nov. 20, 2009 (JP) 2009-265545

(51) Int. Cl. G06K 9/46

(52) U.S. Cl. 382/165; 382/195

(57) ABSTRACT

An object region extraction device according to an exemplary aspect of the invention includes: similar region calculation means 120 for calculating a region of high similarity to a feature extracted from an image; feature region likelihood calculation means 130 for calculating a likelihood of a feature region based on a position of the feature and the similar region; and object region extraction means 140 for extracting an object region based on the likelihood of the feature region. An object region extraction method according to another aspect of the invention includes: obtaining a feature from an image and extracting a position of the feature; calculating a region of high similarity to the feature extracted; calculating a likelihood of a feature region based on the similar region and the position of the feature; and extracting an object region based on the likelihood of the feature region.

### TECHNICAL FIELD

The present invention relates to an object region extraction device and an object region extraction method for extracting an object from an image, and a program for extracting an object region. In particular, the present invention relates to an object region extraction device and an object region extraction method that are capable of extracting an object from an image with high precision, and a program for extracting an object region.

### BACKGROUND ART

In the case of trimming various objects in an image captured by a still camera or a video camera, there is a demand for extracting a desired object region with high precision without wasting time and labor. Examples of a method for separating a captured image into an object region and a background region to extract only the object region include a method of roughly designating an object region and a background region in an image and separating the object region and the background region to thereby extract the object region, and a method of designating a rectangular region including an object region and separating the object region and the background region based on a color distribution inside and outside the rectangular shape to thereby extract the object region.

Non-Patent Literature 1 discloses a technique in which a user manually and roughly designates an object region and a background region in an image to separate the object region and the background region, thereby extracting the object region. The extraction method is a method for separating the background region and the object region by minimizing an energy function including a data term and a smoothing term. This method is called “graph cuts”. Specifically, the data term is defined based on a probability distribution generated from a luminance histogram of each of the object region and the background region designated by the user, and the smoothing term is defined based on a difference in luminance between adjacent pixels.

Non-Patent Literature 2 discloses a method for extracting an object region by designating a rectangular region including an object region from an image to thereby separate the object region and the background region. The extraction method is a modification of graph cuts disclosed in Non-Patent Literature 1. In the technique disclosed in Non-Patent Literature 2, a color distribution model is generated based on the inside of the rectangular region designated as the object region and the outside of the rectangular region designated as the background region, and the color distribution corresponding to each region is used as the data term. This enables the user to extract the object region only by designating the rectangular region including the object region.

Patent Literature 1 discloses a method in which an object of a known shape is detected and designated as an object region in a medical image and a sufficiently large outside range centered on a detecting point is designated as a back ground region to separate the object region and the background region, thereby extracting the object region. In the extraction method, an organ of an extraction target is detected as a point of the object region so as to extract an organ in a medical image. In the technique disclosed in Patent Literature 1, an organ of an extraction target is positioned at the center of the image during photographing, thereby setting the center of the image as a point of the object region. In this method, since the shape of the organ is known to some degree, the organ of the extraction target can be detected using shape information. Further, a region sufficiently apart from a point of the object region is defined as a background region, and the object is extracted using graph cuts (see Non-Patent Literature 1 and Non-Patent Literature 3).

Patent Literature 2 discloses a technique in which a position where an object color exists is designated as an object region by using color information inherent in an object to separate the object region and the background region, thereby extracting the object region. This extraction method uses a method (graph cuts) in which a color inherent in an object, such as the skin of a human, is defined as a probability in advance, and an energy function having a small data term when the probability of including the color is high is used to obtain a separated portion at which the energy function becomes minimum.

### CITATION LIST

### Patent Literature

[Patent Literature 1] Japanese Unexamined Patent Application Publication No. 2008-245719

[Patent Literature 2] Japanese Unexamined Patent Application Publication No. 2007-172224

### Non-Patent Literature

[Non-Patent Literature 1] Yuri Y. Boykov, Marie-Pierre Jolly, “Interactive Graph Cuts for Optimal Boundary and Region Segmentation of Objects in N-D images”, Proc. IEEE Int. Conf. on Computer Vision, 2001

[Non-Patent Literature 2] C. Rother, V. Kolmogorv, A. Blake, “GrabCut: Interactive Foreground Extraction Using Iterated Graph Cuts”, ACM Trans. Graphics (SIGGRAPH '04), vol.23, no.3, pp. 309-314, 2004

[Non-Patent Literature 3] Yuri Boykov and Vladimir Kolmogorov. “An Experimental Comparison of Min-Cut/Max-Flow Algorithms for Energy Minimization in Vision.” In IEEE Transactions on Pattern Analysis and Machine Intelligence (PAMI), September 2004

### SUMMARY OF INVENTION

### Technical Problem

In Non-Patent Literatures 1 and 2, however, it is necessary to manually designate an object region and a background region. In Non-Patent Literature 2, an object color distribution is estimated from a rectangular region including the object region and a background color distribution is estimated from the outside of the rectangular region. This causes a problem in that when a background similar to the object color exists outside the rectangular region, the background is erroneously extracted as the object region.

In the method disclosed in Patent Literature 1, it is necessary to set an object position within the range of the known size of the target object. Accordingly, if the size of the target object varies in the case where a user photographs an image freely, for example, the method cannot be applied. Furthermore, in the method disclosed in Patent Literature 2, a color inherent in an object is designated as an object region. Accordingly, in the case of an automobile, for example, tires can be used as the color inherent in the object, because tires of each automobile have the same color in many cases. However, the automobile body cannot be defined as the color inherent in the object, because automobile bodies generally have various colors. This poses a problem in that tires can be extracted but the entire automobile cannot be extracted.

In view of the above, it is an object of the present invention to provide an object region extraction device and an object region extraction method that are capable of extracting an object from an image with high precision, and a program for extracting an object region.

### Solution to Problem

An object region extraction device according an exemplary aspect of the present invention includes: similar region calculation means for calculating a region of high similarity to a feature extracted from an image; feature region likelihood calculation means for calculating a likelihood of a feature region based on a position of the feature and the similar region; and object region extraction means for extracting an object region based on the likelihood of the feature region.

### Advantageous Effects of Invention

According to an exemplary aspect of the present invention, it is possible to provide an object region extraction device and an object region extraction method that are capable of extracting an object from an image with high precision, and a program for extracting an object region.

### BRIEF DESCRIPTION OF DRAWINGS

FIG. 1 is a block diagram showing an object region extraction device according to a first exemplary embodiment;

FIG. 2 is a block diagram showing another mode of the object region extraction device according to the first exemplary embodiment;

FIG. 3 is a flowchart illustrating a method for extracting an object region using the object region extraction device according to the first exemplary embodiment;

FIG. 4 is a block diagram showing an object region extraction device according to a second exemplary embodiment;

FIG. 5 is a flowchart illustrating a method for extracting an object region using the object region extraction device according to the second exemplary embodiment;

FIG. 6 is a diagram showing an object position likelihood calculated based on a Gaussian distribution with a feature point position of an object as a center;

FIG. 7 is a diagram illustrating a method for calculating an object color likelihood based on the object position likelihood;

FIG. 8 is a diagram showing a background position likelihood calculated based on a Gaussian distribution centered on a feature point position of a background with a position in the vicinity of peripheral four sides of an image as a center of the feature point position;

FIG. 9 is a diagram showing a result of extracting an object region using the object region extraction device according to the second exemplary embodiment;

FIG. 10 is a block diagram showing an object region extraction device according to a third exemplary embodiment;

FIG. 11 is a diagram showing a result of generating an object position likelihood from an object detection result within an object region in the object region extraction device according to the third exemplary embodiment;

FIG. 12 is a block diagram showing an object region extraction device according to a fourth exemplary embodiment; and

FIG. 13 is a diagram showing a result of generating an object position likelihood from a result of detecting a shape inherent in an object in the object region extraction device according to the fourth exemplary embodiment.

### DESCRIPTION OF EMBODIMENTS

### First Exemplary Embodiment

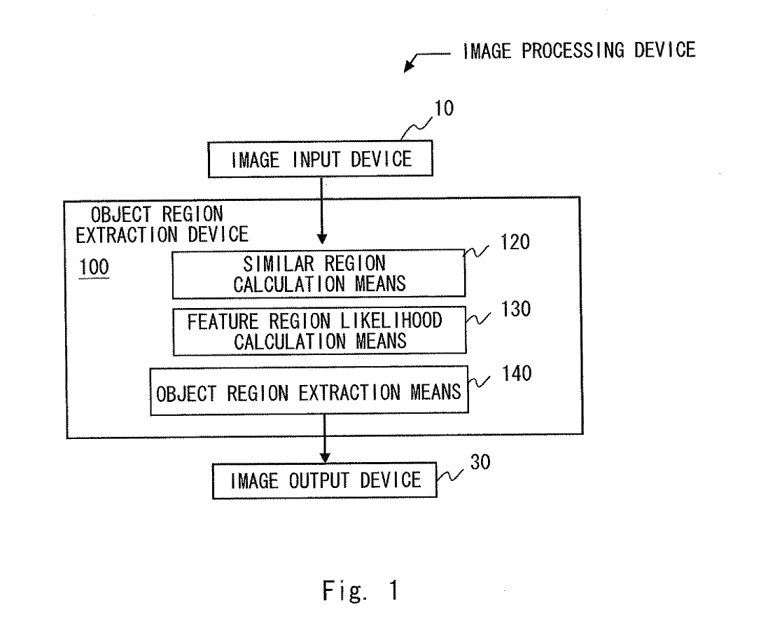

Hereinafter, a first exemplary embodiment of the present invention will be described with reference to the drawings. FIG. 1 is a block diagram showing an object region extraction device according to this exemplary embodiment. An object region extraction device 100 according to this exemplary embodiment includes similar region calculation means 120 that calculates a region of high similarity to a feature extracted from an image; feature region likelihood calculation means 130 that calculates a likelihood of a feature region based on the extracted feature position and the similar region; and object region extraction means 140 that extracts an object region based on the likelihood of the feature region.

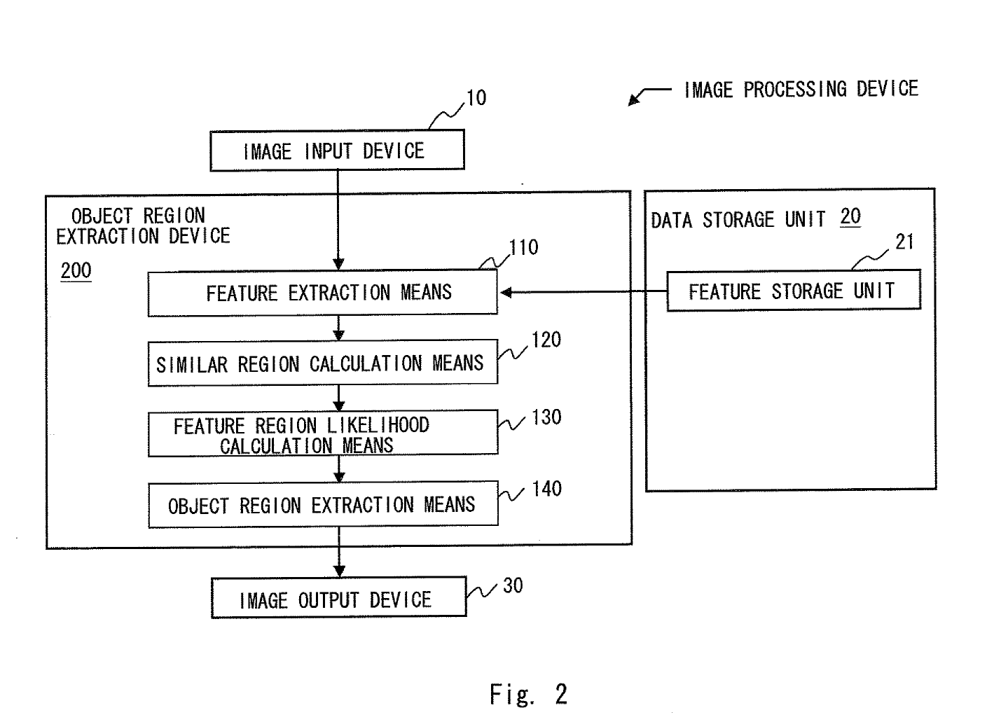

The similar region calculation means 120 calculates a region of high similarity to a feature extracted from an image received from an image input device 10. In the case of extracting a feature from the received image, a user may determine a feature in the image and designate this feature using an input terminal (not shown), for example. As shown in FIG. 2, feature extraction means 110 may be provided at a preceding stage of the similar region calculation means 120, and this feature extraction means 110 may be used to extract a feature from the input image. The term “feature” herein described refers to a feature of an object or a feature of a background.

In the case of extracting a feature from an image using the feature extraction means 110 shown in FIG. 2, a method for extracting features of an object shape, such as Haar-Like features, SIFT features, and HOG features, for example, may be used. Alternatively, a method for extracting a feature of an object color may be used. A feature of an object shape may be combined with a feature of an object color to thereby extract features of an object. More alternatively, desired object features (a feature of an object shape and a feature of an object color) stored in an object feature storage unit 21 of a data storage unit 20 may be compared with a feature extracted from an input image to thereby extract a desired feature from the input image.

The similar region calculation means 120 calculates a similarity between the shape or color of the extracted feature and the shape or color of a peripheral region centered on the position of the feature, for example. In this case, the range of the peripheral region can be determined by generating a Gaussian distribution centered on the position of the extracted feature (the shape of the feature, the color of the feature) and having a dispersion corresponding to the size of the feature. When there are a plurality of extracted features, a plurality of Gaussian distributions are expressed as a Gaussian mixture distribution, and the Gaussian mixture distribution is used to determine the range of the peripheral region. Note that the method for determining the range of the peripheral region is not limited to this, but any other method may be used as long as the range of the peripheral can be determined.

The feature region likelihood calculation means 130 calculates a likelihood of a feature region based on the position of an extracted feature and a region (similar region) of high similarity calculated by the similar region calculation means 120. For example, the feature region likelihood calculation means 130 can calculate the likelihood of the feature region based on the product of the distance between the position of the extracted feature and the region whose similarity has been calculated, and on the similarity. The feature region likelihood calculation means 130 can also calculate the likelihood of the feature region based on the product of the calculated position likelihood and the similarity of the peripheral region centered on the feature position. In this case, the position likelihood can be calculated by generating a Gaussian distribution centered on the position of the extracted feature and having a dispersion corresponding to the size of the feature.

The object region extraction means 140 extracts an object region based on the likelihood of the feature region calculated by the feature region likelihood calculation means 130. The object region extraction means 140 carries out minimization processing on an energy function including a likelihood of a feature region calculated by the feature region likelihood calculation means 130 and a function representing an intensity between adjacent pixels, by using graph cuts method or the like. The use of the minimization processing enables extraction of an object image region from divided regions. The object region extracted by the object region extraction means 140 is sent to an image output device 30.

Note that in this exemplary embodiment, the feature extraction means 110 shown in FIG. 2 may extract positions of features representing an object and a background. The similar region calculation means 120 may calculate a region of high similarity to the feature of the extracted object and a region of high similarity to the feature of the extracted background. The feature region likelihood calculation means 130 may calculate a likelihood of an object region based on the position of the feature of the object and the similar region, and may calculate a likelihood of a background region based on the position of the feature of the background and the similar region. The object region extraction means 140 may extract an object region based on the likelihood of the background region and the likelihood of the object region.

The object region extraction device according to this exemplary embodiment includes the similar region calculation means 120 that calculates a region of high similarity to the extracted feature, and the feature region likelihood calculation means 130 that calculates a likelihood of a feature region based on the position of the extracted feature and the similar region calculated by the similar region calculation means 120. This configuration enables extraction of an object region with high precision. The provision of the feature extraction means 110 shown in FIG. 2 enables automatic extraction of a desired object region from an image, which eliminates troublesome operations for the user.

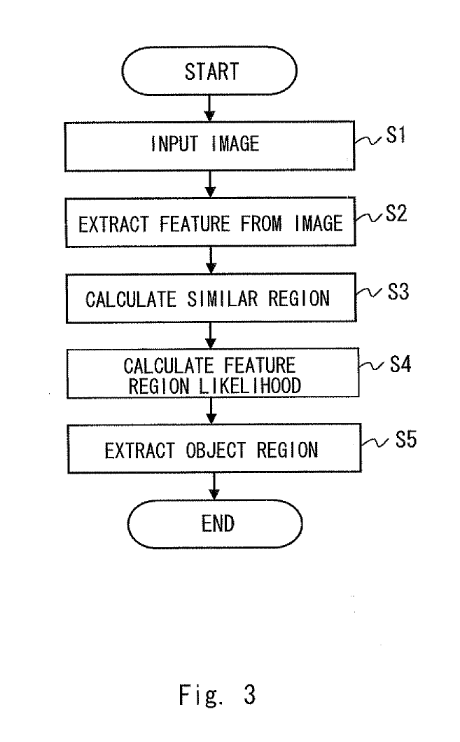

Next, an object region extraction method according to this exemplary embodiment will be described. FIG. 3 is a flowchart illustrating the object extraction method according to this exemplary embodiment. In the case of extracting an object region within an image by using the invention according to this exemplary embodiment, an image to be processed is first input (step S1). Next, a feature is obtained from the image and the position of the feature is extracted (step S2). Then, a region of high similarity to the extracted feature is calculated (step S3). Then, a likelihood of the feature region is calculated based on a similar region and the feature position (step S4). Lastly, the object region is extracted based on the likelihood of the feature region (step S5). In the case of extracting a feature from an image in step S2, the user may manually designate a feature, or a device such as the feature extraction means 110 shown in FIG. 2 may automatically extract a feature, for example. The operation in each step is similar to the operation of the object region extraction device, so a repeated description thereof is omitted.

A program for extracting an object region according to this exemplary embodiment is a program for causing a computer to execute operation including: obtaining a feature from an image; extracting a position of the feature; calculating a region of high similarity to the feature extracted; calculating a likelihood of a feature region based on the similar region and the position of the feature; and extracting an object region based on the likelihood of the feature region. Note that in the case of extracting a feature from an image, the user may manually designate a feature, or a program for extracting features may be used to automatically extract features, for example.

As described above, according to the object region extraction device of this exemplary embodiment, it is possible to provide an object region extraction device and an object region extraction method that are capable of extracting an object from an image with high precision, and to provide a program for extracting an object region. Further, the use of the feature extraction means 110 shown in FIG. 2 eliminates the need to manually extract a feature, and enables automatic extraction of an object from an input image.

### Second Exemplary Embodiment

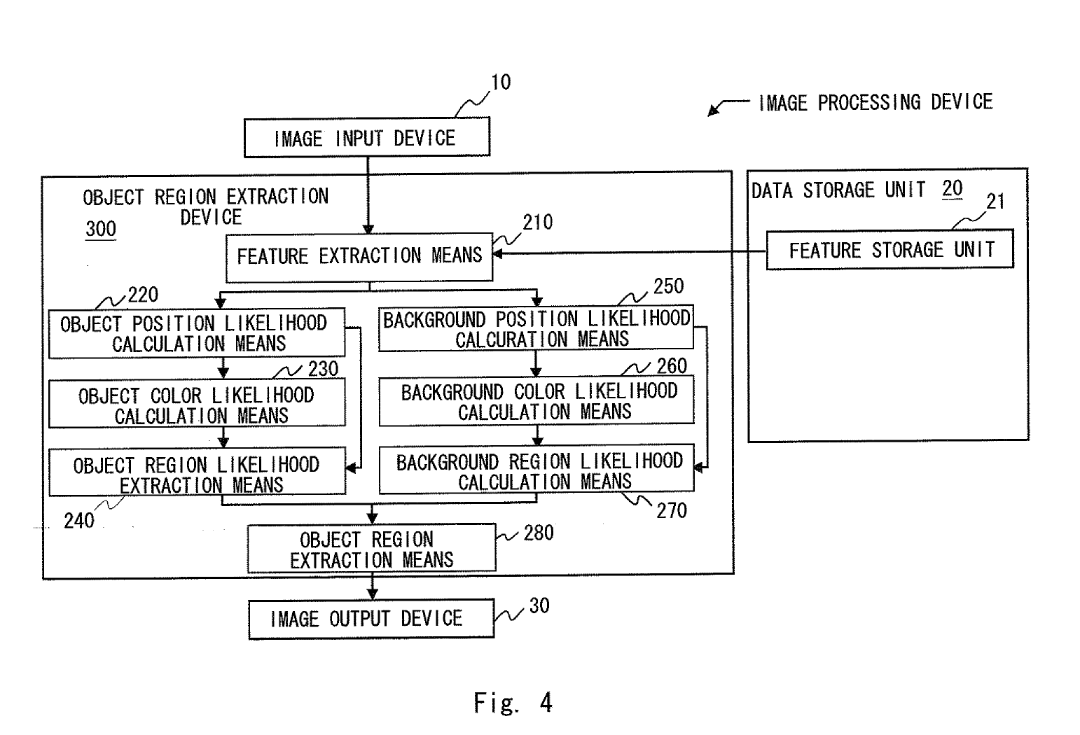

Next, a second exemplary embodiment of the present invention will be described. FIG. 4 is a block diagram showing an object region extraction device according to this exemplary embodiment. As shown in FIG. 4, an object region extraction device 300 according to this exemplary embodiment includes feature extraction means 210, object position likelihood calculation means 220, object color likelihood calculation means 230, object region likelihood calculation means 240, background position likelihood calculation means 250, background color likelihood calculation means 260, background region likelihood calculation means 270, and object region extraction means 280. In addition to the means for calculating a likelihood of an object region, the object region extraction device 300 according to this exemplary embodiment further includes means for calculating a likelihood of a back ground region, that is, the background position likelihood calculation means 250, the background color likelihood calculation means 260, and the background region likelihood calculation means 270. The object region extraction device 300 according to this exemplary embodiment includes the object position likelihood calculation means 220, the object color likelihood calculation means 230, the background position likelihood calculation means 250, and the background color likelihood calculation means 260, as the similar region calculation means 120 described in the first exemplary embodiment. The object region extraction device 300 includes the object region likelihood calculation means 240 and the background region likelihood calculation means 270, as the feature region likelihood calculation means 130 described in the first exemplary embodiment.

The image input device 10 has a function of obtaining an image acquired from an image pickup system, such as a still camera, a video camera, or a copier, or an image posted on a web site, and passing the obtained image to the feature extraction means 210. The feature extraction means 210 extracts a feature from the received image. In the case of extracting a feature from an image, a method for extracting features of an object shape, such as Haar-Like feature, SIFT feature, or HOG feature, or a method for extracting features of an object color may be used. Alternatively, a combination of a feature of an object shape and a feature of an object color may be extracted as features of the object from an image. More alternatively, a desired object feature (a feature of an object shape and a feature of an object color) stored in the object feature storage unit 21 of the data storage unit 20, or a background feature (a feature of a background shape and a feature of a background color) may be compared with the feature (the object feature and the background feature) extracted from the input image, and a desired feature may be extracted from the input image. As described in the first exemplary embodiment, instead of using the feature extraction means 210, the feature extraction may be performed such that the user determines a feature in an image and designates this feature using an input terminal (not shown). In this case, the feature extraction means 210 may be omitted.

The object position likelihood calculation means 220 has a function of calculating a likelihood of a position where an object exists, from a region in which the object exists, based on the feature of the object. The object position likelihood calculation means 220 calculates an object position likelihood by generating a Gaussian distribution centered on the position of the feature of the object extracted by the feature extraction means 210 and having a dispersion corresponding to the size of the feature. Note that when a plurality of features of the object are extracted by the feature extraction means 210, a plurality of Gaussian distributions may be expressed as a Gaussian mixture distribution, and the Gaussian mixture distribution may be used to calculate the object position likelihood.

The object position likelihood calculation means 220 may collate an object using a feature group existing in a predetermined region, and may calculate the object position likelihood based on the collation result. The object position likelihood calculation means 220 may collate the object using a feature group existing in preliminarily divided regions, and may calculate the object position likelihood based on the collation result.

The object color likelihood calculation means 230 has a function of calculating a likelihood of an object color based on the object position likelihood calculated by the object position likelihood calculation means 220. The object color likelihood calculation means 230 sets object position likelihoods in certain pixels generated by the object position likelihood calculation means 220 as candidates for an object color likelihood, and determines the candidate for the object color likelihood having a maximum object color likelihood in the same pixel color among the candidates for the object color likelihood, as the object color likelihood.

The object region likelihood calculation means 240 has a function of calculating a likelihood of an object region based on the object position likelihood calculated by the object position likelihood calculation means 220 and the object color likelihood calculated by the object color likelihood calculation means 230. The object region likelihood calculation means 240 may calculate an object region likelihood based on the product of the calculated object position likelihood and the similarity of the peripheral region centered on the feature position.

Similarly, the background position likelihood calculation means 250 has a function of calculating a likelihood of a position where a background exists, from a region in which the background exists, based on the background feature. The background position likelihood calculation means 250 calculates a background position likelihood by generating a Gaussian distribution centered on the position of the background feature extracted by the feature extraction means 210 and having a dispersion corresponding to the size of the feature. Also in this case, when a plurality of background features are extracted by the feature extraction means 210, a plurality of Gaussian distributions may be expressed as a Gaussian mixture distribution, and the Gaussian mixture distribution may be used to calculate the background position likelihood.

The background color likelihood calculation means 260 has a function of calculating a likelihood of a background color based on the likelihood of the background position. The background color likelihood calculation means 260 sets background position likelihoods in certain pixels generated by the background position likelihood calculation means 250 as likelihood candidates for the background color, and determines a value indicative of a highest likelihood in the same color as the background color likelihood.

The background region likelihood calculation means 270 has a function of calculating a likelihood of a background region based on the background position likelihood calculated by the background position likelihood calculation means 250 and the background color likelihood calculated by the background color likelihood calculation means 260.

The object region extraction means 280 has a function of defining a data term of an energy function based on the likelihood of the object region calculated by the object region likelihood calculation means 240 and the likelihood of the background region calculated by the background region likelihood calculation means 270, minimizing the energy function to divide into an object region and a background region, and extracting the object region. That is, the object region extraction means 280 carries out minimization processing on the energy function including functions representing the object region likelihood calculated by the object region likelihood calculation means 240, the background region likelihood calculated by the background region likelihood calculation means 270, and the intensity between adjacent pixels, by using graph cuts method or the like. An object region can be extracted from the region divided using the minimization processing.

The object region extracted by the object region extraction means 280 is sent to the image output device 30.

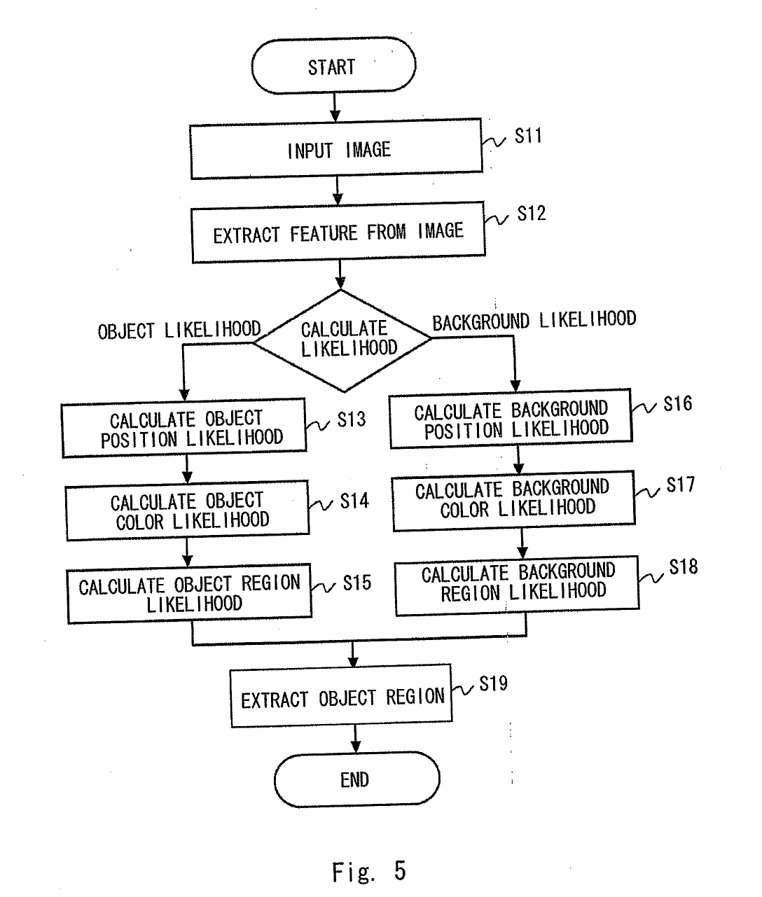

Next, an object region extraction method according to this exemplary embodiment will be described. FIG. 5 is a flowchart illustrating the object region extraction method according to this exemplary embodiment. In the case of extracting an object region within an image by using the invention according to this exemplary embodiment, an image to be processed is input first (step S11). Next, features of an object and a background to be extracted from the image are obtained, and positions of the features representing the object and the background are extracted (step S12). An object position likelihood is then calculated based on the extracted object feature (step S13). An object color likelihood is then calculated based on the calculated object position likelihood (step S14). An object region likelihood is then calculated based on the calculated object position likelihood and object color likelihood (step S15).

Similarly, a background position likelihood is calculated based on the extracted background feature (step S16). Next, a background color likelihood is calculated based on the calculated background position likelihood (step S17). A background region likelihood is then calculated based on the calculated background position likelihood and background color likelihood (step S18). Note that the order of the calculations of the object region likelihood (steps S13 to S15) and the calculations of the background region likelihood (steps S16 to S18) can be arbitrarily set.

Lastly, the object region is extracted based on the calculated object region likelihood and background region likelihood (step S19). Note that the operation in each step is similar to the operation of the object region extraction device described above, so a repeated description thereof is omitted. In the case of extracting a feature from an image, the user may manually designate a feature, or a device such as the feature extraction means 210 shown in FIG. 4 may automatically extract a feature.

Next, a specific example of extracting an object region using the object region extraction device according to this exemplary embodiment will be described. First, features are preliminarily extracted for each object from images including an automobile, woods, sky, road, and the like, and the features for each object are stored in the feature storing unit 21. In the case of extracting features from images including an automobile, woods, sky, road, and the like, for example, SIFT features are extracted. The number of features extracted from all images is about several tens of thousands. Accordingly, about several hundreds of representative features are calculated using a clustering technique such as k-means.

After that, representative features that frequently occur in the image of the automobile are stored as the features of the automobile in the feature storing unit 21. Representative features that frequently occur may be used as features of an object. Alternatively, features of an object may be obtained based on the co-occurrence frequency between features. Note only the SIFT features, but also texture features and the like may be used.

Next, features are extracted from an input image by using the feature extraction means 210. At this time, the features are collated with the features of the automobile stored in the feature storing unit 21 to thereby determine the features of the automobile.

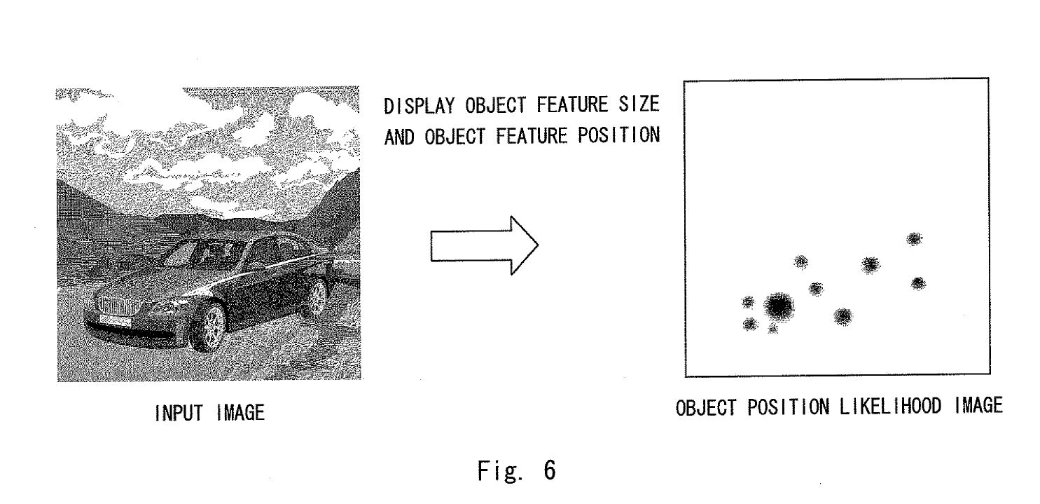

Next, the object position likelihood calculation means 220 calculates an object position likelihood. At this time, it is highly likely that a surrounding region of automobile feature points (positions of automobile features) determined by the feature extraction means 210 is also an automobile region. For this reason, the object position likelihood calculation means 220 calculates the object position likelihood representing the position of the automobile region with the position of each automobile feature point as a reference, based on the Gaussian distribution defined in (Formula 1). FIG. 6 is a diagram showing the object position likelihood calculated based on the Gaussian distribution centered on the position of each feature point of the object.

$$\begin{matrix}[ Formula 1 ] & \\ Pr ( pos \vert O ) = N ( x \vert μ , Σ ) = \frac{1}{2 π \vert Σ \vert} exp \{ - \frac{1}{2} {( x - μ )}^{T} {Σ}^{- 1} ( x - μ ) \} & Formula 1\end{matrix}$$

Herein, “Σ” represents a distribution of features in covariance; “μ,” represents a position of each feature point; “x” represents the vector of a position in the periphery of each feature point; and “T” represents transposition. When there are a plurality of feature points, the object position likelihood is calculated based on the Gaussian mixture distribution shown in (Formula 2). The variance is not limited by the size of the feature, but a constant value may be set as the variance.

$$\begin{matrix}[ Formula 2 ] & \\ Pr ( pos \vert O ) = {\sum }_{k = 1}^{k} {π}_{k} N ( x \vert {μ}_{k} , {Σ}_{k} ) & Formula 2\end{matrix}$$

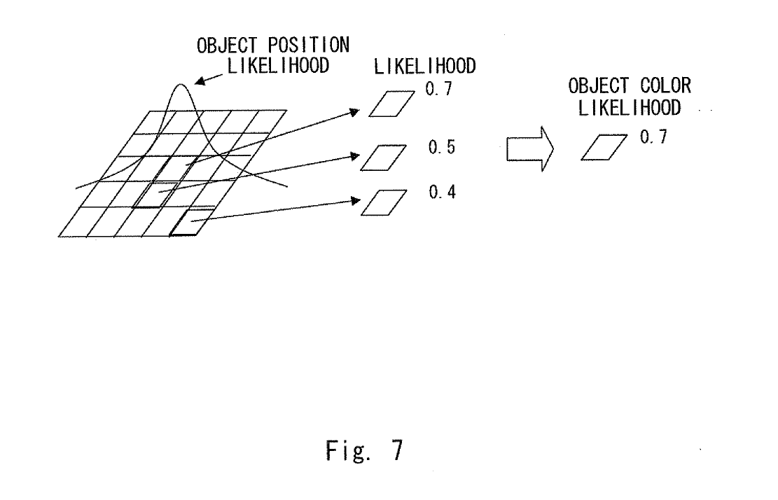

Next, an object color likelihood is calculated based on the object position likelihood, which is obtained by the object position likelihood calculation means 220, by using the object color likelihood calculation means 230. In this case, the object position likelihood set to certain pixel positions are determined as object color likelihood candidates located at the positions. Further, a maximum object color likelihood candidate in the same pixel color is determined as the object color likelihood. FIG. 7 is a diagram illustrating a method for calculating the object color likelihood based on the object position likelihood. As shown in FIG. 7, an object color likelihood candidate having a maximum likelihood (that is, an object color likelihood candidate having a likelihood of 0.7) among three object color likelihood candidates is determined as the object color likelihood. At this time, the object color likelihood can be expressed as (Formula 3).

[Formula 3]

Pr(color|O)=max{Pr(color, pos|O)} Formula 3

In the case of calculating the object color likelihood, an input image may be used, or an image obtained by performing color clustering on an input image may also be used.

Next, the object region likelihood calculation means 240 calculates an object region likelihood in a certain pixel I by using (Formula 4) based on the object position likelihood and the object color likelihood.

[Formula 4]

Pr(I|O)=Pr(pos|O)Pr(color|O) Formula 4

For example, when there is a background similar to the object, the object color likelihood becomes large with respect to the background. As a result, the background may be extracted as an object region based only on the object color likelihood. Accordingly, a restriction is added to the position using the object position likelihood, thereby making it possible to avoid extraction of the background region as the object region.

Next, a background region likelihood is calculated. The background region likelihood can also be calculated in the same manner as in the calculation of the object region likelihood described above.

First, the background position likelihood calculation means 250 calculates the background position likelihood in the same manner as in the method of calculating the position likelihood of the automobile region. That is, the background position likelihood calculation means 250 calculates the background position likelihood based on the Gaussian distribution defined in (Formula 5).

$$\begin{matrix}[ Formula 5 ] & \\ Pr ( pos \vert B ) = {\sum }_{k = 1}^{k} {π}_{k} N ( x \vert {μ}_{k} , {Σ}_{k} ) & Formula 5\end{matrix}$$

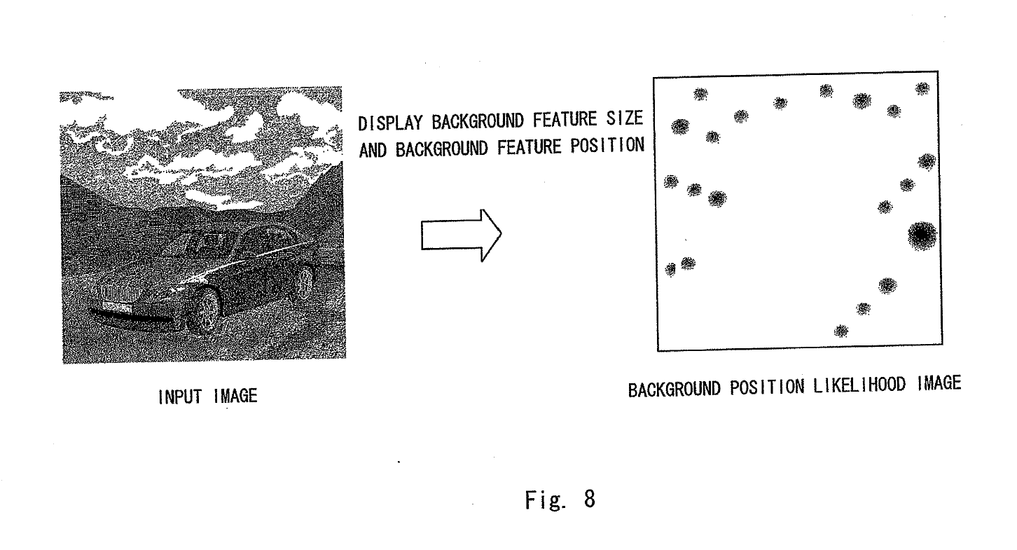

In this case, a Gaussian distribution centered on peripheral four sides of the input image may be set using the previous knowledge that it is highly likely that the background positions correspond to the peripheral four sides in the input image. FIG. 8 is a diagram showing the background position likelihood calculated based on the Gaussian distribution centered on the position of each feature point, with the positions in the vicinity of the peripheral four sides in the image as the center of the feature point positions of the background.

Next, an object color likelihood is calculated based on the object position likelihood, which is obtained by the background position likelihood calculation means 250, by using the background color likelihood calculation means 260. At this time, the background color likelihood can be expressed as (Formula 6).

[Formula 6]

Pr(color|B)=max{Pr(color, pos|B)} Formula 6

In the case of calculating the background color likelihood, an input image may be used, or an image obtained by performing color clustering on an input image may also be used.

Next, the background region likelihood calculation means 270 calculates a background region likelihood in a certain pixel I based on the background position likelihood and the background color likelihood, by using (Formula 7).

[Formula 7]

Pr(I|B)=Pr(pos|B)Pr(color|B) Formula 7

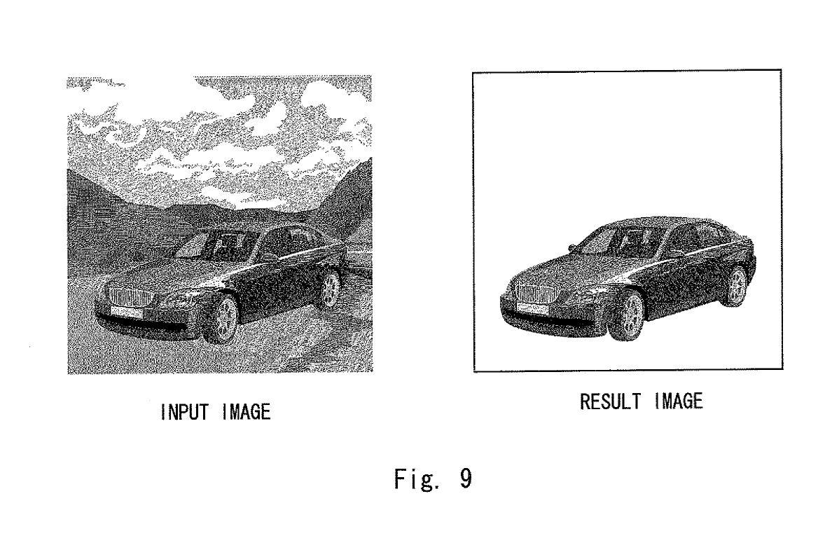

Next, the object region is extracted using graph cuts method. In the graph cuts method, an energy function is defined as in (Formula 8). In (Formula 8), “X” represents a parameter of a ratio between R(I) and B(I); “R(I)” is a penalty function with respect to a region; and “B(I)” is a penalty function representing an intensity between adjacent pixels. An energy function E (Formula 8) defined by R(I) and B(I) is minimized. At this time, R(I) is expressed by (Formula 9) and (Formula 10), and the likelihoods of the object and the background are set. Further, B (I) is expressed by (Formula 11), and a similarity of luminance values between adjacent pixels is set. Herein, |p−q| represents a distance between adjacent pixels p and q. In the graph cuts method, the above-mentioned energy to be minimized is resulted in a minimum-cut maximum-flow theorem, and the graph is segmented using an algorism disclosed in Non-Patent Literature 3, for example, thereby segmenting the region into the object region and the background region. FIG. 9 shows the result of extracting the object region using the object region extraction device according to this exemplary embodiment.

$$\begin{matrix}[ Formula 8 ] & \\ E = λ R ( I ) + B ( I ) & Formula 8 \\ [ Formula 9 ] & \\ R ( obj ) = - ln Pr ( I \vert O ) & Formula 9 \\ [ Formula 10 ] & \\ R ( bkg ) = - ln Pr ( I \vert B ) & Formula 10 \\ [ Formula 11 ] & \\ B ( I ) = exp ( - \frac{{( {I}_{p} - {I}_{q} )}^{2}}{2 {σ}^{2}} ) \cdot \frac{1}{\vert p - q \vert} & Formula 11\end{matrix}$$

Though the above exemplary embodiment illustrates the case of using the graph cuts method as a method for minimizing the energy function, other optimization algorisms such as belief propagation may be used, for example.

As described above, the use of the object region extraction device according to this exemplary embodiment enables extraction of an object from an image with high precision. In particular, the object region extraction device according to this exemplary embodiment calculates the object region likelihood as well as the background region likelihood, thereby making it possible to extract an object from an image with high precision. Furthermore, the use of the feature extraction means 210 eliminates the need to manually extract features, and enables automatic extraction of an object from an input image.

### Third Exemplary Embodiment

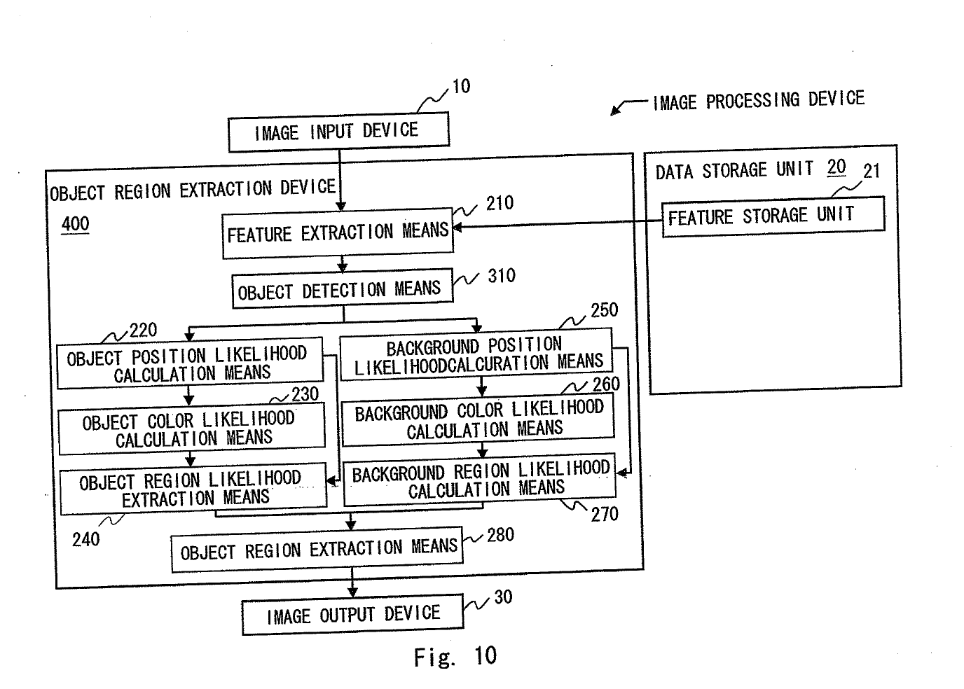

Next, a third exemplary embodiment of the present invention will be described. FIG. 10 is a block diagram showing an object region extraction device according to this exemplary embodiment. As shown in FIG. 10, an object region extraction device 400 according to this exemplary embodiment includes the feature extraction means 210, object detection means 310, the object position likelihood calculation means 220, the object color likelihood calculation means 230, the object region likelihood calculation means 240, the background position likelihood calculation means 250, the background color likelihood calculation means 260, the background region likelihood calculation means 270, and the object region extraction means 280. That is, the object region extraction device 400 according to this exemplary embodiment has a configuration in which the object detection means 310 is added to the object region extraction device 300 described in the second exemplary embodiment. The other components are similar to those of the second exemplary embodiment, so a repeated description thereof is omitted.

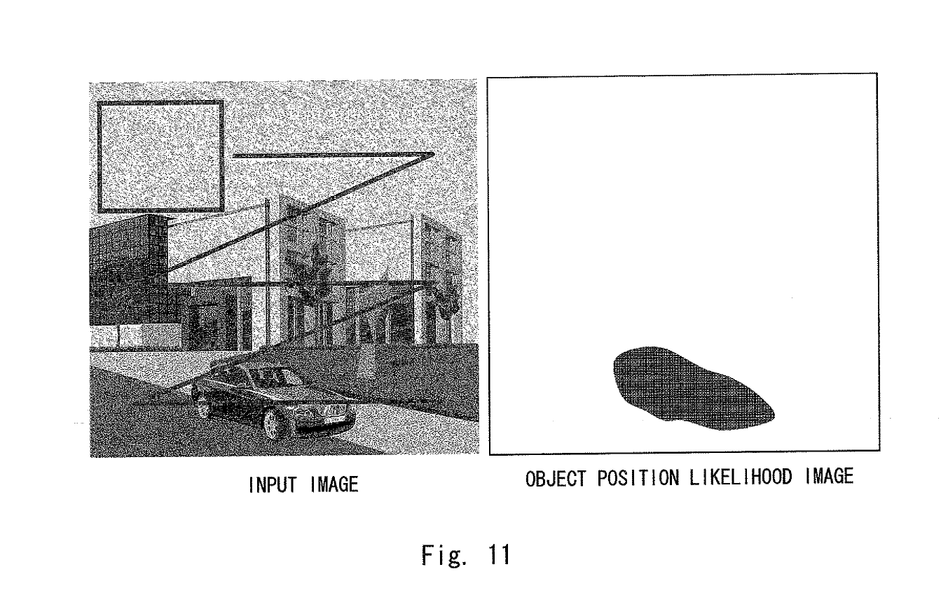

The object detection means 310 detects an object based on features existing in a predetermined region from an input image. In the case of an object-like region, values based on the object likelihood are voted to each pixel of the region. For example, “1” may be set as a value based on the object likelihood when the object likelihood is large, and “0.2” may be set as a value based on the object likelihood when the object likelihood is small. As a result, large values are voted to the object-like region in the input image, and small values are voted to regions that are not like an object. Then, the object position likelihood calculation means 220 normalizes the voted values, so that the voting result can be used as the object position likelihood. FIG. 11 is a diagram showing a result of generating the object position likelihood using such a technique. As shown in FIG. 11, the object position likelihood of the position corresponding to the position of the automobile in the input image is large. The other components are similar to those of the second exemplary embodiment, so the description thereof is omitted.

In the object region extraction device according to this exemplary embodiment, values are voted to each pixel of the object-like region in the entire region by using the object detection means 310, and the object position likelihood is determined based on the voting result. Accordingly, a finer likelihood distribution than that of the object region extraction device according to the second exemplary embodiment can be set to an object having a texture pattern in a predetermined region. Note that the object position likelihood (described in the second exemplary embodiment) which is obtained from the feature points of the object and the object position likelihood obtained using the object detection means 310 may be integrated together.

### Fourth Exemplary Embodiment

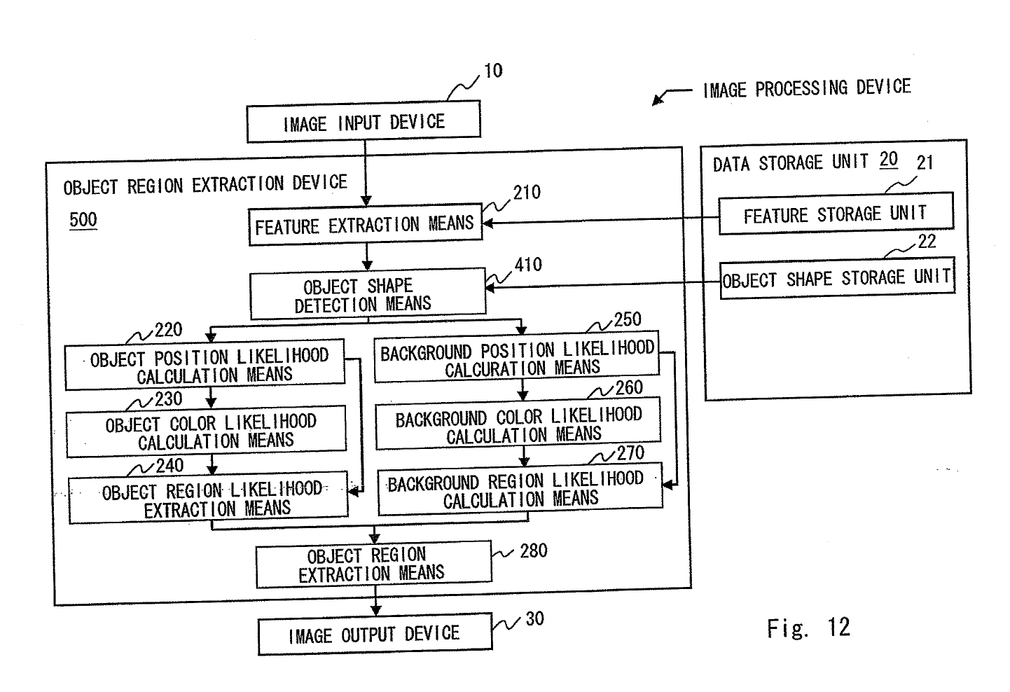

Next, a fourth exemplary embodiment of the present invention will be described. FIG. 12 is a block diagram showing an object region extraction device according to this exemplary embodiment. As shown in FIG. 12, an object region extraction device 500 according to this exemplary embodiment includes the feature extraction means 210, object shape detection means 410, the object position likelihood calculation means 220, the object color likelihood calculation means 230, the object region likelihood calculation means 240, the background position likelihood calculation means 250, the background color likelihood calculation means 260, the background region likelihood calculation means 270, and the object region extraction means 280. That is, the object region extraction device 500 according to this exemplary embodiment has a configuration in which the object shape detection means 410 is added to the object region extraction device 300 described in the second exemplary embodiment. In this exemplary embodiment, the data storage unit 20 is provided with an object shape storage unit 22. The other components are similar to those of the second exemplary embodiment, so a repeated description thereof is omitted.

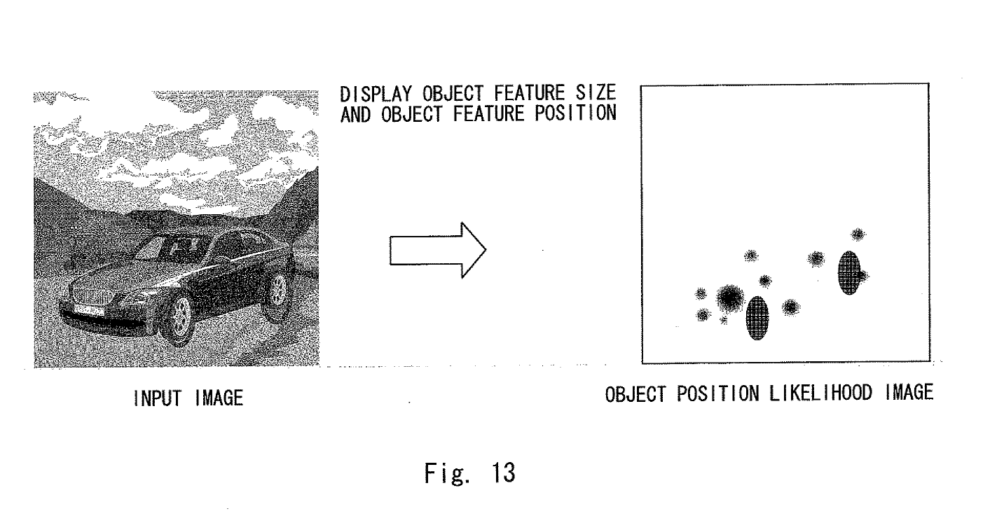

The object shape detection means 410 detects the shape inherent in an object from an input image by collating the shape with the object shape stored in the object shape storage unit 22. For example, in the case of extracting an automobile as an object region, a tire may be used as the shape inherent in the object. In this case, the object shape detection means 410 collates the shape with the shape of the tire stored in the object shape storage unit 22, thereby detecting an elliptical shape, which is the shape of the tire, from the input image. Then, the detected elliptical shape is processed using a preliminarily set threshold for the tire. Further, a large object likelihood is set to the position of the elliptical shape obtained after the threshold processing, and is integrated with the object position likelihood calculated by the object position likelihood calculation means 220. FIG. 13 is a diagram showing a result of generating the object position likelihood from the detection result of the shape (tire) inherent in the object. A diagram on the right side of FIG. 13 shows a state where the shape (tire) inherent in the object, which is obtained by the object shape detection means 410, and the object position likelihood, which is calculated by the object position likelihood calculation means 220, are integrated together. The other components are similar to those of the second exemplary embodiment, so the description thereof is omitted.

In the object region extraction device according to this exemplary embodiment, the shape inherent in an object is detected by the object shape detection means 410, and a large object position likelihood is set to the position of the detected shape inherent in the object. Accordingly, the shape of an object which is hardly extracted as a feature point can also be detected as the shape inherent in the object. This enables setting of a finer distribution of the object position likelihood as compared to the object region extraction device according to the second exemplary embodiment.

As described in the above exemplary embodiments, the present invention can also be implemented by causing a CPU (Central Processing Unit) to execute any processing as a computer program. The above-mentioned program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

While the present invention has been described with reference to exemplary embodiments, the present invention is not limited to the above exemplary embodiments. The configuration and details of the present invention can be modified in various manners which can be understood by those skilled in the art within the scope of the invention.

This application is based upon and claims the benefit of priority from Japanese patent application No. 2009-265545, filed on Nov. 20, 2009, the disclosure of which is incorporated herein in its entirety by reference.

### INDUSTRIAL APPLICABILITY

The present invention is widely applicable to image processing fields involving extraction of a desired object from an input image.

### REFERENCE SIGNS LIST

100 OBJECT REGION EXTRACTION DEVICE

110 FEATURE EXTRACTION MEANS

120 SIMILAR REGION CALCULATION MEANS

130 FEATURE REGION LIKELIHOOD CALCULATION MEANS

140 OBJECT REGION EXTRACTION MEANS

200, 300, 400, 500 OBJECT REGION EXTRACTION DEVICE

210 FEATURE EXTRACTION MEANS

220 OBJECT POSITION LIKELIHOOD CALCULATION MEANS

230 OBJECT COLOR LIKELIHOOD CALCULATION MEANS

240 OBJECT REGION LIKELIHOOD CALCULATION MEANS

250 BACKGROUND POSITION LIKELIHOOD CALCULATION MEANS

260 BACKGROUND COLOR LIKELIHOOD CALCULATION MEANS

270 BACKGROUND REGION LIKELIHOOD CALCULATION MEANS

280 OBJECT REGION EXTRACTION MEANS

310 OBJECT DETECTION MEANS

410 OBJECT SHAPE DETECTION MEANS

1. An object region extraction device comprising:
similar region calculation unit configured to calculate a region of high similarity to a feature extracted from an image;
feature region likelihood calculation unit configured to calculate a likelihood of a feature region based on a position of the feature and the similar region; and
object region extraction unit configured to obtain an object region based on the likelihood of the feature region.

2. The object region extraction device according to claim 1, wherein the object region extraction device further comprises feature extraction unit configured to obtain a feature from the image and extracting a position of the feature.

3. The object region extraction device according to claim 1, wherein the similar region calculation unit calculates a similarity between a shape or a color of the extracted feature and a shape or a color of a peripheral region centered on the position of the feature.

4. The object region extraction device according to claim 3, wherein a range of the peripheral region is determined by generating a Gaussian distribution centered on the position of the feature and having a dispersion corresponding to a size of the feature.

5. The object region extraction device according to claim 4, wherein when a plurality of features are extracted, a plurality of Gaussian distributions are expressed as a Gaussian mixture distribution, and the Gaussian mixture distribution is used to determine the range of the peripheral region.

6. The object region extraction device according to claim 1, wherein the feature region likelihood calculation unit calculates a likelihood of the feature region by a product of a distance between a position of the extracted feature and a region whose similarity is calculated, and the similarity.

7. The object region extraction device according to claim 2, wherein
the feature extraction unit extracts positions of features representing an object and a background,
the similar region calculation unit calculates a region of high similarity to the extracted feature of the object and a region of high similarity to the extracted feature of the background,
the feature region likelihood calculation unit calculates a likelihood of an object region based on the position of the feature of the object and the similar region, and calculates a likelihood of a background region based on the position of the feature of the background and the similar region, and
the object region extraction unit extracts an object region based on the likelihood of the object region and the likelihood of the background region.

8. The object region extraction device according to claim 1, wherein
the similar region calculation unit comprises:
object position likelihood calculation unit configured to calculate a likelihood of a position where the object exists in a region in which the object exists, based on a feature of the object; and
object color likelihood calculation unit configured to calculate an object color likelihood based on the object position likelihood calculated by the object position likelihood calculation unit, and
the feature region likelihood calculation unit comprises object region likelihood calculation unit configured to calculate an object region likelihood based on the object position likelihood and the object color likelihood.

9. The object region extraction device according to claim 8, wherein
the similar region calculation unit further comprises:
background position likelihood calculation unit configured to calculate a likelihood of a position where the background exists in a region in which the background exists, based on a feature of the background; and
background color likelihood calculation unit configured to calculate a background color likelihood based on the background position likelihood calculated by the background position likelihood calculation unit, and
the feature region likelihood calculation unit further comprises background region likelihood calculation unit configured to calculate a background region likelihood based on the background position likelihood and the background color likelihood.

10. The object region extraction device according to claim 9, wherein
the object position likelihood calculation unit calculates the object position likelihood by generating a Gaussian distribution centered on the position of the feature and having a dispersion corresponding to a size of the feature, and
the background position likelihood calculation unit calculates the background position likelihood by generating a Gaussian distribution centered on the position of the feature and having a dispersion corresponding to a size of the feature.

11. The object region extraction device according to claim 9, wherein
the object color likelihood calculation unit sets object position likelihoods in certain pixels generated by the object position likelihood calculation unit as candidates for an object color likelihood, and sets a candidate for the object color likelihood candidate having a maximum object color likelihood in the same pixel color among the candidates for the object color likelihood, as the object color likelihood, and
the background color likelihood calculation unit sets background position likelihoods in certain pixels generated by the background position likelihood calculation unit as candidates for a background color likelihood, and sets a candidate for the background color likelihood candidate having a maximum background color likelihood in the same pixel color among the candidates for the background color likelihood, as the background color likelihood.

12. The object region extraction device according to claims 8, wherein the object position likelihood calculation unit performs collation of an object using a group of features existing in a predetermined region, and calculates an object position likelihood based on a result of the collation.

13. The object region extraction device according to claim 8, wherein the object position likelihood calculation unit performs collation of an object using a group of features existing in a preliminarily divided region, and calculates an object position likelihood based on a result of the collation.

14. The object region extraction device according to claim 8, wherein the object region likelihood calculation unit calculates an object region likelihood based on a product of the calculated object position likelihood and a similarity of a peripheral region centered on a feature position.

15. The object region extraction device according to claim 8, wherein the object region extraction means separates all pixels into an object region and a background region to extract the object region based on the object region likelihood and the background region likelihood so as to minimize a function for calculating a posterior probability of an object and a background in each pixel and a function whose value increases with an increase in similarity of luminance between adjacent pixels.

16. The object region extraction device according to claim 8, wherein
the object region extraction device further comprises object detection unit configured to vote a value based on an object likelihood to each pixel of a region, and
the object position likelihood calculation unit uses a result obtained by normalizing the voted value of the object detection unit, as an object position likelihood.

17. The object region extraction device according to claim 8, wherein
the object region extraction device further comprises object shape detection unit configured to detect a shape inherent in an object from an input image by performing collation with information on a preliminarily set object shape, and
the object position likelihood calculation unit integrates the calculated object position likelihood with information on the shape inherent in the object detected by the object shape detection unit.

18. An object region extraction method comprising:
obtaining a feature from an image and extracting a position of the feature;
calculating a region of high similarity to the feature extracted;
calculating a likelihood of a feature region based on the similar region and the position of the feature; and
extracting an object region based on the likelihood of the feature region.

19. A non-transitory computer-readable medium for causing a computer to execute operation comprising:
obtaining a feature from an image and extracting a position of the feature;
calculating a region of high similarity to the feature extracted;
calculating a likelihood of a feature region based on the similar region and the position of the feature; and
extracting an object region based on the likelihood of the feature region.
